(19) United States
(12) Patent Application Publication
(10) Pub. No.: US 2019/0034246 A1
(43) Pub. Date: Jan. 31, 2019

(54) SYSTEMS AND METHODS FOR ADAPTIVE COMPUTER CODE PROCESSING BY COMPUTING RESOURCE STATE-AWARE FIRMWARE

(71) Applicant: SWFL, Inc., d/b/a "Filament", Reno, NV (US)

(72) Inventors: Jeremie Miller, Reno, NV (US); Thomas Muldowney, Reno, NV (US); Allison Clift-Jennings, Reno, NV (US)

(21) Appl. No.: 15/662,591

(22) Filed: Jul. 28, 2017

(51) Int. Cl. G06F 9/50; G06F 9/455

(52) U.S. Cl. CPC G06F 9/5094; G06F 2009/45583; G06F 9/45558

(57) ABSTRACT

The systems and methods for operating an autonomous device with a constraint-aware firmware includes: identifying a request to execute a script; identifying one or more computing resource costs associated with executing the script by one or more computing resources of the autonomous device; detecting a state of each of the one or more computing resources of the autonomous device; in response to (i) identifying the one or more computing resource costs and (ii) detecting the state each of the one or more computing resources of the autonomous device, executing or not executing the scripts.

### TECHNICAL FIELD

The inventions of the present application relate generally to the field of autonomous device operations, and more specifically to improved systems and methods for implementing firmware and virtual machine for constraint-aware execution of code.

### BACKGROUND

In many centralized systems, many devices across great and small distances can achieve heightened levels of connectivity and interaction without being physically connected to each other and thus, are able to connect and communicate with one another wirelessly. These centralized systems for connecting these devices, however, are accompanied with several disadvantages that limit connectivity in remote locations, limit the autonomy of the devices operating in the centralized systems, and therefore, do not allow for optimal connectivity, autonomous transacting, and communications between and through the devices.

Additionally, due to the inherent lure of abuse and exploitation by centralized systems, all of these economic elements, digital and physical, with existing systems or new products, must be fundamentally autonomous and distributed in nature in order to maximize their potential. It is only in autonomous and distributed environments that markets can naturally emerge, balancing and maximizing benefit for all those involved.

The commonly referred to proposal to evolve the Internet to optimize for the “Internet of Things” has become synonymous with connected thermostats, pet collars, and toothbrushes. While the ability to build connectivity between devices like these is novel, there is a possibility that it may not realize the full potential of digitally connecting the physical world of things together. When a device can only connect with similarly-manufactured devices, and each of them can only connect with their manufacturer-approved cloud service, the vast majority of value that the device could have provided over its lifetime is severely hindered since it is strictly tied to a cloud-based interaction platform.

These new economic actors—i.e., the devices themselves—must be principal actors independent from centralized authority (e.g., manufacturers and connectivity servers) to unlock the vast majority of value associated therewith. Including—and especially—from the manufacturers of the devices themselves. It can be a very risky proposition to continue to give central authority, whether a nation state or a corporation, the reach and control over this new type of connected device. These autonomous and fully interconnected devices should retain full control and complete privacy at the device providing the coupling and creating the economic value.

But in order to realize such prospective technical environments where devices are independent actors, the technical functions involved in connectivity including discovery, interacting, and even transacting value between devices and with people. The need for strong security applies to the entire protocol stack, systems, and methods governing these technical functions and must be re-evaluated from the ground up. Additionally, due to the constrained nature of the autonomous device having a limited power source, memory, computing power and the like, it is also necessary that the system operates in a state of awareness of the device's limitations such that operational decisions by the machine do not exhaust the resources of the autonomous device.

Thus, there is a need in the device connectivity and communication field to create new and useful systems and methods for implementing an environment for interactivity of autonomous devices without or independent of a central authority for governing interaction there between and consequently, enhancing the levels and quality of connectivity achievable with such networks and devices. There is also a need in the autonomous device field to create new and useful systems and methods for constraint-aware execution of the functions and operations of the autonomous device.

### BRIEF DESCRIPTION OF THE FIGURES

FIG. 1 illustrates a system 100 in accordance with one or more embodiments of the present application;

FIG. 2 illustrates a schematic of an autonomous device of the system 100 in accordance with one or more embodiments of the present application; and

FIG. 3 illustrates a method 300 in accordance with one or more embodiments of the present application.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### Overview

Autonomous devices and the like may be used for implementing transactions of various types. Many of these autonomous devices are very limited in nature; meaning that the autonomous devices are, in many instances, constrained devices in one or more respects including, but not limited to, having limited processing capabilities, security capabilities, limited storage capacity/capabilities, limited battery or energy capacity, limited connectivity, and the like.

The limited or constrained nature of the autonomous devices presents a number of concerns that permeate into an ability of the autonomous device to securely perform transaction and in an energy-conservative manner since many of the autonomous devices, as they relate to the embodiments of the present application, are often not connected to continuous (e.g., plug-in) power sources.

Thus, because of the limited nature of the autonomous devices, it is often beneficial to operate a JavaScript application or the like via a JavaScript virtual machine for interpreting and executing instructions of the autonomous devices. While running a JavaScript virtual machine may, in some instances, obviate the limited computing capabilities of a constrained device, running the JavaScript virtual machine often requires significant amounts of energy to sustain its normal processing operations. For instance, a JavaScript virtual machine running a JavaScript application is often required to frequently check in with (or take control of) the autonomous machine, which consumes a great amount of energy thereby limiting a battery life of the autonomous machine.

Accordingly, in order to preserve the energy resources of a limited power, constrained, autonomous device, it is ideal to reduce the power consumption of a virtual machine that operates the functionality of the autonomous device without sacrificing the capabilities of the autonomous device to operate securely. In particular, a virtual machine that is run without awareness of device constraints can result in denial of service to the autonomous device through premature draining of a battery or other energy-storage system.

In view of the above limitations and requirements of an autonomous device, the embodiments of the present application provide a virtual machine with capabilities to dynamically operate lambda functions that may be called from a remote or disparate computing resource. The virtual machine may be a constraint-aware entity that is capable of identifying among other things the energy constraints of a constrained autonomous device on which it operates and discern functionalities and operations that should be performed using lambda functions. Accordingly, the constraint-aware virtual machine discerns when lambda functions are needed for an operation of the autonomous device based on a power level of the autonomous device.

### 1. System for Firmware Operations on a Constrained Device

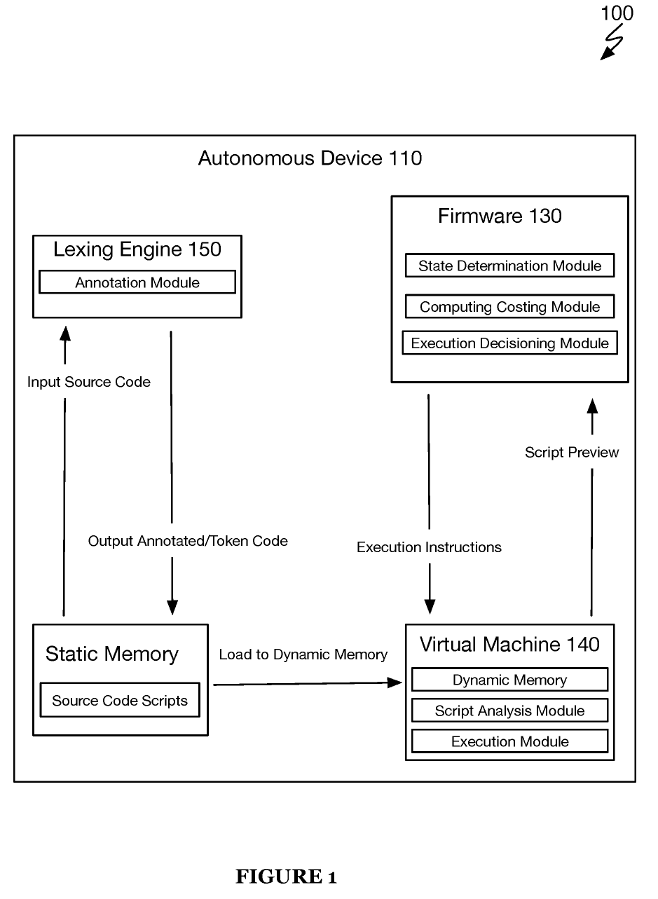

As shown in FIG. 1, a system 100 for operating a computing resource state-aware firmware and virtual machine is illustrated. The system 100 includes an autonomous device 110 having firmware 130, a virtual machine 140, and a lexing engine 150.

The system 100 functions to optimize operations of an autonomous device with respect to several computing resources available to the autonomous device. In many embodiments of the present application, the system 100 implements a JavaScript virtual machine and specially designed firmware to manage operations of a constrained device while maintaining security and energy requirements of the constrained device. It shall be noted that while the embodiments of the present application preferably embody the use of a JavaScript virtual machine, it is envisioned that any suitable virtual machine may be used by the system 100 to implement the desired functionality of the autonomous device 110. Thus, the configuration and implementation of system 100 takes into account the limited computing and operational resources of a constrained autonomous device when executing scripts and other machine code that affect the available resources of the device. Additionally, system 100 functions to implement a combination of novel techniques that improve the utilization of various computing resources of a constrained device.

A constrained device as referred to herein may relate to or include devices that are constrained in code space (e.g., memory), processing capabilities (e.g., computer processing power), and other computing aspects such that they cannot easily interact with other nodes employing a full protocol stack and related security protocols; however, these types of constrained devices may be capable enough to use a protocol stack (e.g., Blocklet) specifically designed for these types of constrained devices. While these types of constrained devices may be able to participate in a network with peers and employ meaningful security functions, they need to be parsimonious with state memory, code space, and often power expenditure for protocol and application usage.

The autonomous device 110 is preferably a device that is a principally independent actor from a central authority including any central server authority and including manufacturers of the autonomous device. That is, the autonomous device is able to manage all of its operations, transactions, access, transacting with other devices, an operational control of the device without intervention of a central authority outside of the physical device. Thus, the autonomous device retains full control and complete privacy at the device, itself, when in use and operation.

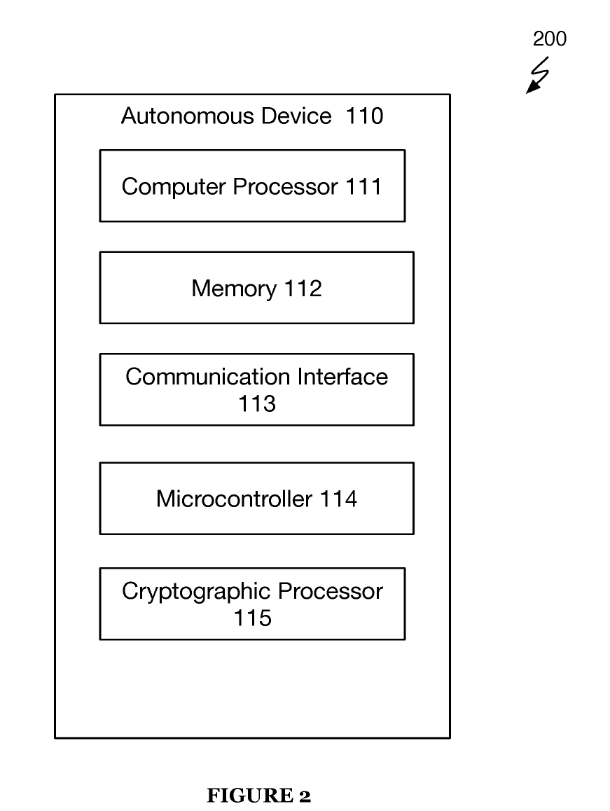

As shown in FIG. 2, each autonomous device 110 of system 100 comprises one or more computer processors 111 (or a main central processing unit iii), a memory 112 (static and dynamic memory), and a communication interface 113. In one variation, each autonomous device includes a microcontroller 114 having a small computer on a single integrated circuit containing a processor core, memory, and programmable input/output peripherals. The microcontroller 114, in some embodiments, is used in lieu of the one or more computer processors 111 and in other embodiments, the microcontroller is used in conjunction with the one or more computer processors 111. Additionally, and/or alternatively, the autonomous device 110 includes a cryptographic coprocessor 115 which is a hardware security module or component which provides high security and high-throughput cryptographic subsystems and a crypto-accelerator chip 116, which may be integrated with the cryptographic coprocessor 115. The autonomous device 110 may also include a modulator 117, an oscillator 118, a timer/clock 119, and a power supply 120.

The autonomous device 110 of FIG. 2 may also include traditional elements of a device configured for radio communication at the communication interface 113. Thus, the communication interface 113 of autonomous device 110 of a preferred embodiment includes a radio frequency (RF) scanner 121, RF transmitter 122, RF receiver 123, RF tuner 124, an antenna 125, and a RF amplifier 126.

The memory 112 of the autonomous device 110 in a preferred embodiment includes one or more computer-executable instructions and/or software applications with computer code for executing the functionality and protocols of DIST including Telehash and TMesh (described U.S. patent application Ser. No. 15/345,414, which is incorporated herein by reference in its entirety) and any other functionality or protocols associated therewith, which are described herein required for secure and private communications by and between each of the plurality of nodes 110 and another node.

The cryptographic coprocessor 115 of the autonomous device 110 may be configured to implement various cryptographic processes including generating, managing, and storing cryptography keys and encrypting and decrypting cryptographically secured communications. Specifically, each autonomous device using the cryptographic coprocessor 115 is able to generate private/public cryptographic key pairs that can be used to cryptographically secure communication links and sessions between at least two nodes.

The autonomous device 110 may be any type of device (e.g., semi- or fully autonomous), which may be coupled with one or more machines, instruments, components, and/or real world operational devices or elements to sense inputs and/or outputs thereof, to perform actuation operations of one or more components thereof, to perform transactions on behalf of the element or device to which the autonomous device is coupled, and the like. For example, in some embodiments, the autonomous device comprises a sensor that is able to obtain readings and other information relating to or about one or more devices to which the sensor is operably coupled and/or obtain readings about the environment of the one or more devices. Additionally, and/or alternatively, the autonomous device may be an actuator that performs and/or controls one or more actuation operations of a device to which the actuator is a component and/or is operably coupled to. In yet another example, the autonomous device may be a transaction device which brokers transactions on behalf of the device to which it is operably coupled and/or forms a component thereof. The transaction may include an exchange of value for a good, service, or other product offered to the autonomous device or the device to which the autonomous device is coupled. In such example, the autonomous device acting as a transaction device is able to negotiate with other devices and/or other autonomous devices to obtain resources for itself and the device to which it is coupled or provide resources from the device to which it is coupled for a negotiated value or the like from another device or party.

The firmware 130 may include software permanently provided to the autonomous device no. The firmware 130 may be specifically designed to effectuate autonomous control, monitoring, and data processing functions of the autonomous device. The firmware 130 may include specific software instructions that allow it to be continuously and/or periodically aware of a state of any computing and/or operational resource of the autonomous device. The firmware 130 may be provided in a non-volatile memory, such as ROM, EEPROM, or flash memory of an integrated circuit (e.g., microcontroller, microcomputer, GPU, etc.).

The virtual machine 140 is preferably in operable communication and command communication with the firmware 130. The virtual machine 140 may be configured to execute various functions and operations of the autonomous device and preferably, performs these functions and operations dynamically by executing dynamically loadable scripts, such as sets of lambda functions, in view of the requirements of digital smart contracts (e.g., Blocklet contracts) or similar. The virtual machine 130 may be implemented by a segment of computer processing element (e.g., microcontroller, microcomputer, CPU, GPU, etc.) of the autonomous device.

In a preferred embodiment, the virtual machine 140 may be primarily configured to selectively and/or dynamically execute only segments of source code or individual lambda functions. Thus, the virtual machine 140 running lambda functions is capable of interjecting script and logic on demand and preferably, only when necessary. Each lambda function may include a string of code that, when executed by the virtual machine or the like, allows the autonomous device to perform a single function or operation. Each string of code may be defined based on a lexical analysis by the lexing engine 150, as described in more detail below. Additionally, each lambda function may be associated with cost parameters that indicate computing resource costs associated with the execution of the lambda function. For instance, the computing resource costs may include and/or relate to processing memory usage, computer processing usage, battery or energy supply usage, and the like. Thus, in some embodiments, computing resource costs of the lambda function may be evaluated by the firmware 130 in one or more of its decisioning processes prior to execution of the lambda function by the virtual machine 130. In some embodiments, the firmware 130 may be in operable communication with one or more sensors (e.g., heat sensor, energy sensor, memory sensor, any suitable sensor, etc.) where each sensor is associated with a computing resource of the autonomous device to allow the firmware to obtain and/or request computing resource data and/or state data from each of the sensors. In this way, the firmware 130 may base its one or more control instructions to the virtual machine 140 on whether the computing resource costs for executing a specific lambda function exceed an amount that the autonomous device no can expend without exhausting the computing resources of the autonomous device and/or diminishing critical functionality of the autonomous device 110.

In operation, the virtual machine 140 additionally functions to decompose a script (e.g., a script containing a set of lambda functions) to expose logic and control operations of the script to the firmware 130. Accordingly, unlike a traditional virtual machine, the virtual machine 140 does not merely execute the scripts provided for execution, but also reveals the basic operational attributes of the script to the firmware 130 that allows for a novel cooperation between the firmware 130 and the virtual machine 140 in the specific and granular control of the operations of the autonomous device. This means that the firmware 130 may always be aware of the functions being executed by the virtual machine 140 and the operations performed by the autonomous device 110 and correspondingly, always be aware of and in control of the computing resource costs associated with each executed script and, at a more granular level, the costs associated with executing each control and/or logic operation of the script.

In operation, the virtual machine 140 may be able to specifically identify control operations and logic functions of a script based on annotations made to the script by the lexing engine 150. Alternatively, the virtual machine 140 may be specifically programmed with capabilities similar to the lexing engine 150 in order to specifically identify each of the control operations and/or logic of a script prior to executing the script.

Decomposition of the control operations and logic of a script generally allows for a revelation of these functions to the firmware 130 for decisioning but also, allows for an identification of critical actions, operations, or functions of a script. In this way, these actions, operations, of functions may be classified and/or ranked to allow the firmware 130 to determine whether selective execution of some of these functions should be performed even when the computing resources of the autonomous are severely diminished (or severely constrained).

The loading of scripts to be executed by the virtual machine is preferably governed based on a Blocklet contract (e.g., a digital smart contract). The digital smart contract, in some embodiments, embodies the terms of a real-world contract; however, the terms (e.g., JSON Web Tokens, etc.) are constructed into the digital smart contract in such a way so that they are machine-enforceable. Accordingly, the scripts to be executed by the virtual machine may be uploaded dynamically into memory based on events and/or occurrences that are authorized based on the digital smart contract. That is, only events recognized under the digital smart contract can trigger the upload of a script to be executed by the virtual machine.

The lexing engine 150 is preferably in operable communication with firmware 130 and preferably includes one or more tools for analyzing the syntax of source code or a source-level program to identify control and/or logic operations in the source code. Specifically, the lexing engine 150 functions to scan source code or the like and based on the identified syntax, including logic and control structures, of the source code, the lexing engine 150 generates tokens, which preferably identify a string of code (e.g., code blocks) from the source code that defines a specific function or operation performable by executing the string.

In some embodiments, the lexing engine 150 uses pointers or types of markers (e.g., flags, etc.) to identify tokens or strings of code that perform a specific operation. The lexing engine 150 may similarly use pointers or markers to specifically and separately identify the logic and control operators within a string of code.

The lexing engine 150 is preferably implemented in an on-demand basis such that the lexing engine 150 only functions to lex the source code of a script or program when a specific function within the source code is needed or is being used by the virtual machine 140 or the like. Implementing the lexing engine 150 in this way resultantly preserves the very limited computing resources (e.g., computer processing, memory, battery, etc.) of an autonomous device because various sections of the source code of a script or program that are not needed or that will not be used are not processed by the lexing engine 150, and thus not passed to the virtual machine 140 or the like for execution.

In this vein, the lexing engine 150 preferably selectively lexes portions of source code, as needed. For instance, in some embodiments, the lexing engine 150, when lexing source code, functions to lex a top part of a script or program to identify an intent of the code or operations of the autonomous device performable by the code, but may skip lexing the body of the code until the lexing engine 150 is made aware by the firmware or the like that some or all of the functionality of the source code is required for execution. Accordingly, the lexing engine 150 preferably functions to lex only individual blocks of code on an as-needed or on-demand basis.

Additionally, a parsing engine (not shown) may be implemented in combination with the lexing engine 150 to analyze the strings of source code.

Additionally, a copy of the source code once processed by the lexing engine 150 is preferably not copied to a memory of the autonomous device no. In a preferred embodiment, (only) the annotations made to the source code including the placement of pointers and various markers and their associated locations are stored in a jump table or branch table. In this preferred embodiment, the lexed source code may not be compiled into byte code. Rather, using as a reference the annotations of the source code stored in a jump table, the virtual machine 130 is able to execute selected functions directly from the source code. In other words, the virtual machine 130 functions to execute-from-source.

### 2. Method for Firmware and Virtual Machine Operations on a Constrained Device

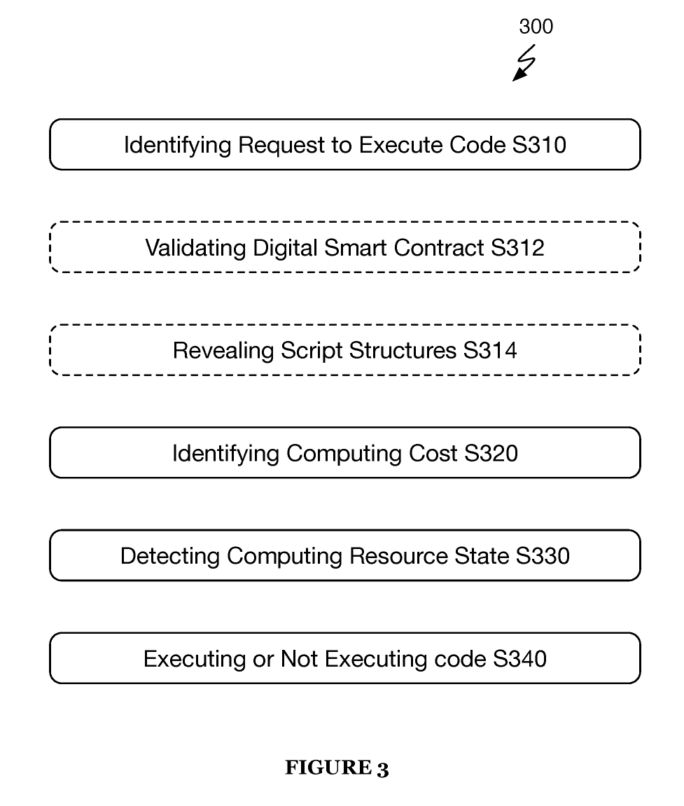

Referring to FIG. 3, FIG. 3 illustrates a method 300 of a preferred embodiment of the present application for processing scripts of code on-demand using an operating firmware and a virtual machine of an autonomous device. The method 300 includes identifying a request to execute machine-executable code S310, identifying a cost associated with executing the machine-readable code S320, detecting a state of computing resources of an autonomous device S330, executing or not executing the machine-readable code S340. The method 300 may optionally include validating the script against a digital smart contract S312 and revealing control operations and logic structures of the script to a firmware of the autonomous device prior to execution of the script S314.

The method 300 functions to optimize operations of an autonomous device with respect to several computing resources available to the autonomous device. In many embodiments of the present application, the method 300 is implemented by the systems of an autonomous device having limited computing resources and thus, functionally operates as a constrained device. The method 300 considers the very limited nature of the autonomous device and implements protocols and techniques via the firmware and/or the virtual machine that allow for granular control of the functions executed by the autonomous device to ensure a high level of security and also, selectively executes scripts and code in a manner to preserve the computing resources (e.g., battery or energy resources) of the autonomous device.

The method 300, in some embodiments, implements a firmware of the autonomous device that is operably aware of the state of the autonomous device and in particular, aware of the state of the one or more computing and operating resources of the autonomous device. In this regard, the firmware may be implemented such that it has constant, continuous, or selective awareness of any and all of the limited computing and operational resources of the autonomous device. This allows the firmware to intelligently and selectively control the functions and operations of the virtual machine of the autonomous device based on the state of the computing and operational resources of the autonomous device.

In some embodiments, the method 300 implements a virtual machine that may operate to execute dynamically loaded scripts in a transparent and efficient manner based on control commands of firmware of an autonomous device. The virtual machine, as implemented by method 300, functions to identify, from dynamic memory, one or more scripts or blocks of machine code to be executed. The virtual machine is capable of identifying the one or more control operations and logic of script to be executed and prior to executing the script, revealing to the firmware each of the control operations and logic of a script. This operation by the virtual machine allows the firmware to selectively and granularly determine which control operations and/or logic of a script should be executed by the virtual machine dependent on a state of the autonomous device. Thus, while the method 300 implements the virtual machine to execute scripts and the like, the execution operation of the virtual machine is modifiable or limited by the command instructions from the firmware regarding a subject script that is to be executed. This interaction between the virtual machine and the firmware provides several advantages, as mentioned briefly above, mainly relating to the granular control and security achieved by making the execution of a script or the like by the virtual machine subject to a selection and/or confirmation process of the firmware.

Additional benefits relating also mainly to the perseveration and intelligent use of the computing resources of the autonomous device are also achieved because the awareness by the firmware of the state of the computing and operating resources of the autonomous device informs the commands from the firmware to the virtual machine as to the execution parameters for a script. The execution parameters for a script may include, but is not limited to, which parts (e.g., control operations and/or logic) of the script to execute, when (e.g., a time or sequence) to execute the script, how to execute the script or portions of the script (e.g., a number of times to execute control operations, such as looping), and the like.

S310, which includes identifying a request to execute machine code, functions to enable the recognition by a virtual machine and/or firmware of a request to execute machine code for performing one or more functions or operations of the autonomous device. Additionally, or alternatively, the request may include instructions or a command to execute the machine code.

In a first implementation, a virtual machine of the present application identifies a script processing request based on receiving a script that is automatically invoked to the virtual machine based on an occurrence of an event. The event triggering the invocation of the script and associated script processing request to the virtual machine may be any type of event that is predefined by an event source. For instance, the event source may be a memory module associated with the autonomous device comprising a plurality of pre-defined events and corresponding digital associations to scripts. In another instance, the event source may be determined based on one or more terms identifiable in one or more digital smart contracts that generally govern the privileges and rights to operation or use the autonomous device. For instance, if the autonomous device is an actuator, a digital smart contract for the actuator may include the terms by which the actuator performs actuation functions. In such an instance, the performance of an actuation may be predicated on a performance by a party to the digital smart contract and based on the occurrence of that performance (or triggering event), a script for performing an actuation by the autonomous device is automatically presented to the virtual machine for execution. Thus, in some embodiments, the one or more digital smart contracts may define the events or occurrences which may trigger one or more operations of the autonomous device. The defined events or occurrences of a digital smart contract may be the single event source for triggering the invocation of scripts to the virtual machine, but, in some embodiments, the events or occurrences of a digital smart contract may be considered with additional event sources defined outside of the digital smart contract. These additional event sources may be expressly written to the firmware of the autonomous device or, as mentioned above, may be included separately from the terms of the digital smart contract in an independent events reference table of scheduled or predefined events stored in some memory module (e.g., static memory) of the autonomous device.

The scripts are preferably written in the form of lambda functions that may be expressly associated with or linked to events that cause the scripts to be automatically invoked. It shall be noted, however, that the scripts may be written in any suitable form or manner.

In this first implementation, upon identifying the script processing request and associated script, the virtual machine preferably validates the functions and operations performable by executing the script against one or more digital smart contract S312. Thus, in some embodiments, the script processing request preferably identifies a digital smart contract providing authorization for executing the script. In such embodiment, the virtual machine identifies the digital smart contract and the terms therein to determine, at least, whether the function of the presented script matches an approved function (e.g., privilege or right, etc.) defined within the digital smart contract and also, whether an occurrence or an event defined in the digital smart contract for triggering the functions performable by executing the script has been satisfied.

In one variation, the script processing request includes the script to be executed but does not identify the digital smart contract authorizing the execution of the script. In such case, the virtual machine does not automatically execute or begin processing the script. Rather, prior to processing the script, the virtual machine searches for a digital smart contract that specifies terms for performing the functions and/or operations of the script in order to validate the script. As mentioned before, the virtual machine may also determine from the terms of the digital smart contract the events or occurrences that trigger the invocation of the script and further, validate whether the events or occurrences are satisfied before processing the script.

In another variation, a reference table having approved scripts functions and associated with triggering events or occurrences may be provided or made available to the virtual machine for the purposes of validating the script before processing or execution of the script. In one embodiment, the functions and triggering events of the reference table are determined and/or generated based on terms of the one or more digital smart contracts associated with the subject autonomous device. The reference table may be presented or delivered with the script processing request or may be retrievable by the virtual machine for reference and validation of the script processing request.

S314, which includes disassembling the script to identify its control operational structures and logic structures, functions to preview the control operations and logic of the script to the firmware of the autonomous device. This may be performed in response to a successful validation of the script and/or script processing request against a digital smart contract or the like. The preview of the control operations and logic of the script pending execution by the virtual machine allows the firmware an opportunity to evaluate the script for the purposes of determining costs associated with executing the entire script and/or select control operations and/or logic of the script. Thus, the virtual machine previews the components of the script and maintains the script in a pending-for-execution state awaiting specific execution commands by the firmware of the autonomous device.

S314 may disassemble the script for preview based on annotations to the script as provided by a lexing engine. The annotations to the script may preferably include pointers and various markers for indicating control operations, logic, and/or specific text of the script. In this way, based on the pointers and various markers, the virtual machine is able to segregate the components of the script and subsequently, present those components to the firmware for additional analysis and decisioning.

In a second implementation, a virtual machine identifies a script processing request based on instructions provided by, or an indication provided based on, an occurrence of an event (e.g., a performance of an action, etc.) (triggering event) that triggers a request for a performance of an action (triggered action) or the like required under a digital smart contract. Thus, in this second implementation, the occurrence of the event may trigger an instruction to the virtual machine to request or retrieve a specific script or to execute a specific lambda function. Alternatively, the occurrence of the event may trigger an indication that a triggering event has been detected together with the presentation of the terms of an associated digital smart contract. The virtual machine, in such implementation, may identify the action response terms (e.g., triggered actions) of the digital smart contract and correspondingly identify one or more scripts to be executed.

Accordingly, the virtual machine may retrieve the appropriate script for execution based on the instructions or indication triggered by the occurrence of the event. In retrieving the script, the script may be automatically uploaded to dynamic memory for execution by the virtual machine and no additional validation (e.g., against the digital smart contract) of the script may be necessary.

In yet a third implementation, the identification of the script processing request may be based on actions initiated by the virtual machine based on an event source or a predetermined schedule of events. In this implementation, an event source (e.g., sensor, event detection device, etc.) may continuously or periodically report occurrences or events to the virtual machine, which may cause the virtual machine to initiate identification processes for identifying scripts that should be processed based on the reports of the occurrences or events. Additionally, or alternatively, the virtual machine may identify a script processing request based on a predetermined schedule of events. For instance, a predetermined schedule of events may be provided in a memory module of the autonomous device where the predetermined schedule identifies some or all of the events or occurrences (e.g., triggering events). Thus, the virtual machine may periodically or continuously check the predetermined schedule to identify impending or past events or occurrences in order to retrieve or call a script for execution.

S320, which includes identifying a cost associated with executing the machine code, functions to determine direct and indirect costs to the autonomous device of executing the machine code or script. S320 includes determining each of the cost-incurring control operations and logic functions of a script. As mentioned above, at step S314, the virtual machine may function to disassemble a script pending for execution and reveal the control operations, logic functions, and any other cost-incurring components of the script. In this way, the firmware may easily identify cost drivers of a script that is pending execution. In one variation, if S314 is not implemented, the virtual machine may be able to identify the cost-incurring functionality of script by referencing annotations to the script or machine code stored in a storage medium (e.g., a jump table storing pointers and annotation markers).

S320 functions to determine direct costs associated with executing the pending script. The direct costs associated with executing the pending script may typically include computing resource costs and various operational costs for implementing one or more real-world operations by the autonomous device. For instance, the computing resources costs may include and/or relate to a cost to process the script by the portion of a main CPU operating the virtual machine (e.g., processing time and processing/computing power), a cost to allocate portions of memory during the pre-execution, execution, and post-execution processes involved in executing the script, a cost relating to a battery or limited energy supply used in powering other computing resources (e.g., the main CPU) for the executing the script or powering other operational resources (e.g., components of an actuator) of the autonomous device, and the like.

S320 further includes identifying indirect or implicit costs of executing the script. These indirect or implicit costs mainly relate to opportunity costs associated with executing the pending script. For instance, when (or after) executing the script the limited resources of the autonomous device may be unavailable to be used by one or more other operations or functions of the autonomous device. The indirect costs associated with the missed opportunities to execute some of these operations or functions are determined and may be considered in an overall cost value associated with executing the script.

As a few examples, the executing and/or processing of the script by the virtual machine may incur a direct time cost (e.g., 10 seconds) and correspondingly, incur indirect costs associated with possibly preventing the implementation of one or more security protocols, preventing the processing and transmission of operational communications, and the like. These opportunity costs may be evaluated by the virtual machine equally as direct costs. However, in a preferred embodiment, the identified indirect costs may be afforded a lower weight (e.g., 40%) than the direct costs (e.g., 60%).

S320 functions to determine, in various manners, the costs associated with executing the script. In a first implementation, S320 may determine costs associated based on historical execution costs associated with executing the same or a substantially similar script or specific functions (e.g., lambda functions) thereof. In this first implementation, the firmware may be able to identify a same script that was executed at a time in the past (historically) by the autonomous device. If the parameters of the computing and operational resources of the autonomous device are the same or substantially the same, the firmware may estimate the cost of running the current script as being the same as the historical costs for running the prior script. In the case that the firmware is unable to identify a same script, the firmware may alternatively estimate the cost of running the script based on historical costs of running a substantially similar script. The firmware may modify the historical costs of running a substantially similar script to increase the cost estimate or to reduce the cost estimate in light of the extent of the differences in the control operations and logic between the script and the substantially similar script.

In a second implementation, S320 may determine costs associated with the pending script by primarily by evaluating each of the control operations and logic operations of the script (and other cost-incurring components of the script) revealed by the virtual machine. In this regard, S320 using the firmware may identify historical costs associated with running same or similar control operations and logic as in the script. S320 may use the historical value of executing the same or similar control operations and logic to infer and/or generate a cost values for each of the control operations and logic. Similar, as above, if or when S320 is not able to identify a same control operation or logic as one existing in the pending script, S320 may modify historical cost values for similar or substantially similar to increase or decrease the values to match the increase or decrease in control operations or logic complexity or the like to arrive at cost values for the pending script.

In one embodiment, S320 may determine costs associated with executing a script and/or costs associated with executing the control operations and logic of a script by interpolating the cost values for the script between known historical values for executing same or similar scripts. In this regard, S320 may function to calculate a cost value for each cost-incurring operation of a script based on the firmware's comprehension of the differences in the complexity of the control operations and logic between the pending script and the historical cost values of previously executed scripts.

In a third implementation of S320, S320 functions to determine costs associated with executing a script based on a predetermined cost schedule for executing scripts. In such implementation, the predetermined cost schedule includes cost values for all scripts that the virtual machine may execute. The predetermined cost schedule may be updated periodically to include cost values for executing new scripts to the autonomous device. The predetermined cost schedule can also be updated to include modified or new cost values based on an actual cost incurred by the autonomous device in executing the script. Thus, the firmware may continuously measure actual cost values for executing a script against the predetermined cost schedule and when a discrepancy is identified between an actual cost value and a predetermined cost value in the schedule, the firmware may update the predetermined cost schedule to reflect the more recent or accurate cost value. In this implementation, since a firmware implementing S320 has access to the predetermined schedule, the firmware may be considered a computing-cost-aware firmware, which may be firmware that is always aware of the costs for executing a script.

In a fourth implementation, S320 may generate or estimate cost values for executing the script, by analyzing the cost-incurring functions and logic of the script and running a surrogate function (e.g., surrogate algorithm). The cost-incurring functions and logic of the script may be used as input into a surrogate function or algorithm that predicts or estimates cost values for executing a script. In this implementation, once the script or cost-incurring components of the script are provided as inputs into the surrogate function, the surrogate function may function to simulate the processes that would be incurred by each of the computing and/or operational resources of the autonomous device and estimate the cost for implementing each process. The surrogate function may sum these estimated or calculated costs to provide a cost value for executing the script. Accordingly, the surrogate function of this implementation would allow the autonomous device to computationally determine the costs for executing the script without actually running the script using the virtual machine 140 or the like.

In yet a further implementation, S320 may identify the cost associated with executing the script based on the script processing request. In this further implementation, the script processing request may include the script as well as computing and operational cost data for executing the script. S320 may evaluate the provided computing and operational cost data and validate the computing and operational cost data against historical values associated with executing a script or a predetermined cost schedule or the like.

S330, which includes detecting a state of one or more computing resources of the autonomous device, functions to determine state data (e.g., status) for each computing resource and/or operational resource that will be implemented in executing the script. The state data for each computing resource and/or operational resource may include data relating to a current and/or future state of the computing and/or operational resource. The state data may include whether or not the computing and/or operational resource is currently in use, recent use data, future or scheduled use data, energy level or amount (e.g., battery life, etc.), computational processing power available, available memory, positioning information (e.g., actuated or unactuated state), operational or non-operational data, and the like. Thus, the state data may be any suitable data or information about a computing resource and/or an operational resource of the autonomous device that may be affected by the execution of the script.

Preferably, in response to a pending execution of a script by a virtual machine, the firmware may be automatically triggered to detect state data for each of the computing and/or operational resources of the autonomous device. In this way, to preserve battery life/energy supply of the autonomous device or the like, state data for the computing and/or operational resource components of the autonomous device may only be requested in response to the pending execution of the script (e.g., indication by the virtual machine that a script processing request is received, pending execution, or the like). In this regard, the firmware may automatically ping or request state information from each of the computing resources and/or operational resources that will be affected by the execution of the script to obtain state data.

In another implementation, computing resources and/or operational resources of the autonomous device may continuously or periodically transmit or report state data to the firmware. The computing resources and operational resources of the autonomous device may intelligently implement reporting of state information to the firmware based on detecting a script processing request, detecting a critical event, and/or one or more predetermined script execution schedules or the like. By intelligently reporting state information based on an occurrence of a critical event (e.g., receipt of script processing request by the virtual machine 140), the firmware may maintain sufficient and timely awareness when decisioning whether or not to have the virtual machine execute a script.

S340, which includes executing or not executing the script, functions to determine whether or not to execute the pending script based script execution parameters. The script execution factors include the analysis and consideration of one or more of the state data of the one or more computing and/or operational resources and computing and/or operational cost data. Additionally, or alternatively, S340 the script execution factors may include consideration of execution parameters and execution thresholds that inform the decisioning to execute or not to execute a script or selective control operations or logic of a script. The decisioning of S340 is preferably implemented by the firmware but may be performed by any suitable component of the autonomous device.

In one implementation of S340, execution parameters include a set of predetermined conditions that define when or if a script should be executed by the virtual machine. The predetermined conditions may identify a plurality of execution thresholds that if satisfied by one of or a combination of the state data and cost data may trigger an execution command to the virtual machine.

In one example, a pending script request may include a script that requires five-percent (5%) of a battery life of the autonomous device to fully execute by the virtual machine. An execution condition may be set such that execution of a script should only be performed if the computing resource cost of executing the script does not exceed ten-percent (10%) of a current battery energy level. In such example, the state data may include an indication of a battery energy level of fifty-percent (50%). The firmware decisioning the execution of the script may evaluate the computing cost (5% of battery life) against the condition and the current battery energy level (50%) and determine that execution of the script is permitted because the pending script processing request satisfies the execution condition since the execution cost of 5% consumption of battery life does not exceed 10% of the 50% remaining battery life of the autonomous device.

In a second implementation of S340, execution parameters include condition and/or threshold continuum for decisioning whether selective functions/operations of the script should be executed. The continuum may include a plurality of conditions and/or thresholds preferably in an increasing or decreasing manner across the continuum representing the increasing or decreasing requirements of the conditions or thresholds.

As an example, a pending script processing request may include a script with five control operations. A predefined threshold continuum may be provided for governing execution based on a memory resource (or an energy resource) of the autonomous device. In this example, the threshold continuum includes three thresholds including a first threshold at thirty-percent (30%), a second threshold at fifty-percent (50%), and a third threshold at seventy-five (75%) available memory. Each of the threshold levels indicating permissible level of execution of a script. For instance, if available memory is above the third threshold, it may be permitted to execute the pending script in its entirety; if the available memory is between the second and third thresholds, it may only be permissible to execute sixty-percent (65%) of the control operations of the pending script; if the available memory is between the first and the second thresholds, it may only be permissible to execute twenty-percent (20%) of the control operations of the pending script; and if the available falls below the first threshold, the script should not be executed at all or only designated critical control operations (e.g., security controls, etc.) should be executed by the virtual machine. In this example still, state data of the memory resource of the autonomous device may indicate that the available memory level is at seventy-three percent (73%), which lies between the second and third thresholds. In such case, the firmware evaluating the state data of the autonomous device against the threshold continuum may provide command instructions to the virtual machine to execute only 60% of the control operations of the pending script. In which case, the virtual machine would execute three out of the five control operations of the script, preferably based on a ranking or critical nature of the control operations of the script. In some embodiments, the firmware also selectively identifies which of the five control operations that should be executed based on a ranking, criticality, and/or importance of the control operations of the script.

In a third implementation of S340, execution parameters may include generating or determining an execution score for the pending script processing request. The execution score may be a dynamically calculated value determined by one or more of the computer processing elements of the autonomous device, but is preferably calculated by the firmware prior to executing or not executing a script. The execution score preferably provides an indication of whether a script or the control operations and logic in a script should or should not be executed by the virtual machine. The execution score may be a global score that is applicable to more than individual instances of script processing requests and may apply to a plurality of continuous or discontinuous script processing requests. For instance, if an execution score that is calculated by the firmware is sufficiently low, it is possible that the execution score may affect the executability of a current pending script as well as subsequent pending scripts, as the execution score may indicate serious deficiencies in the autonomous device's computing resources and therefore, ability to compute and/or execute scripts.

The execution score or value may be represented by a numerical value in a range of numerical values (e.g., ex. score: 43 of range: 9 to 63). The execution score or value may also be represented as a non-numerical value, such as “High,” “Intermediate,” and “Low”. The execution score may be calculated based on one of or a combination of computing resource state data, script execution cost data, other pending scripts for execution, and other factors relating to or affecting executability of the pending script. Each factor used in calculating the execution score may be assigned a predetermined weight and a portion of the execution score is determined by the multiplication of the predetermined weight by a value of the factor, where the value of the factor is based on one or more of a computing resource state data value and a script execution score value.

As an example, based on a pending script request, a firmware of an autonomous device determines computing resource state data and computing resource cost data of the pending script. Applying a first weight and a second weight to the state data and cost data, respectively, the firmware calculates an execution score. In this example, the first weight may be different than the second weight; however, in some examples, the weights may be the same. If the calculated execution score satisfies or exceeds an execution score threshold value, then the firmware will generate instructions to the virtual machine to execute the script. Conversely, if the calculated execution score does not satisfy the execution score threshold, the firmware will generate instructions to the firmware to not execute only selective control operations of the script or not to execute the script at all.

Additionally, or alternatively, another factor relating to a ranking or criticality of the script may be taken into consideration at S340. For instance, each of the scripts may be assigned a rank of importance based on the functionality or operations that they provide, when executed. Some scripts, which function to provide basic or fundamental operations of the autonomous device relating to security, communication, and the like, may be assigned a higher rank or level of criticality. Oppositely, those scripts which provide ancillary or less important functionality, such as reporting, monitoring, or the like, may be assigned lower rankings and/or levels of criticality. The ranking level or criticality level assigned to a script may assist in informing the execution decisioning by the firmware. For instance, even if an execution score for a pending script request does not meet or satisfy an execution score threshold, a level of criticality assigned to the pending script may dictate that at least the critical control operations should be executed. The assigned criticality or ranking may identify the critical control operations so that the firmware may selectively indicate, with instructions to the virtual machine, which control operations should be executed and the other control operations not executed. The ranking may be based on whether or not an identified control operation or logic operation satisfies or exceeds a critical-to-operation threshold. A control operation or logic operation may be assigned a high ranking (or a low numerical ranking, e.g., 1 of 1-10) based on whether the control operation is important to the operation of the autonomous device and correspondingly satisfies or exceeds the threshold. Similarly, a control operation or logic operation may be assigned a low ranking (or a high numerical ranking, e.g., 9 of 1-10) based on whether the control operation is not important or critical to the operation of the autonomous device and correspondingly does not satisfy or exceed the critical-to-operations threshold; meaning that the control operation or logic of the script is not entirely necessary for the continued operation or substantial continued functionality (e.g., a security function, important communications, etc.) of the autonomous device.

Additionally, or alternatively, for those scripts or control operations of scripts that are not executed by the virtual machine, the virtual machine may redirect these unexecuted scripts and/or control operations to a script queue that allows these unexecuted scripts or control operations to remain pending until an execution parameter is met. For example, the autonomous device may be recharge and thus, the battery life returns to an acceptable level. Or, a large operation has been completed by the autonomous device, which frees available memory therefore allowing additional scripts to be executed.

Accordingly, in response to an analysis of the computing resource state data and the execution or computing cost data in view of the execution parameters, S340 may directly inform the decisioning of whether or not to execute a pending script or whether or not to execute portions of the pending script. In the case that S340 determines not to execute a pending script, the not-to-execute instructions to the firmware may include additional instructions for redirecting the script for later execution (e.g., placing the script in a queue) or providing a schedule for executing the script at a later time. In the case that S340 determines to execute a pending script, the execute instructions may include instructions to execute the script in its entirety or execute selective control operations and/or logic of the script. The execution instructions may also include a schedule for executing the control operations and/or logic of the script based on ranking or criticality. For instance, if one of the functions of the script includes a loop that is scheduled to be run indefinitely, the instructions from the firmware or the like may include a limit (e.g., run loop 10 times or for toms) for executing the loop. In this way, the firmware may maintain granular control of the execution of the functions of the script in view of the limited computing resources of the autonomous device.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application-specific processor, but any suitable dedicated hardware or hardware/firmware combination device can alternatively or additionally execute the instructions.

Although omitted for conciseness, the preferred embodiments include every combination and permutation of the implementations of the systems and methods described herein, including system 100 and method 300.

As a person skilled in the art will recognize from the previous detailed description and from the figures and claims, modifications and changes can be made to the preferred embodiments of the invention without departing from the scope of this invention defined in the following claims.

What is claimed is:

1. A system of operating an autonomous device using an energy-aware firmware, the system comprising:
an autonomous device having:
an energy source that powers one or more operations of the autonomous device;
a virtual machine that receives a script processing request, wherein the script processing request identifies a computer-executable script;
a firmware that is in operable command communication with the virtual machine;
prior to executing the script, the virtual machine analyzes the script and reveals to the firmware each of one or more control functions of the script and/or one or more logic functions of the script;
wherein, in response to the revealed information, the firmware determines:
(i) an energy state of the energy source, the energy state indicating an amount of power available to perform the one or more operations of the autonomous device;
(ii) an energy cost for executing the script, wherein the energy cost indicates an amount of power required by the autonomous device to execute the script;
(iii) generating execution instructions based on the energy state of the energy source and the energy cost for executing the script, wherein the execution instructions indicate whether or not to execute the script by the virtual machine; and
(iv) transmitting the execution instructions to the virtual machine.

2. The system of claim 1, further comprising:
at the virtual machine:
receiving the execution instructions indicating whether or not to execute the script;
wherein if the execution instructions include instructions to execute the script, identifying which of the one or more control functions of the script and/or the one or more logic functions of the script to execute; and
selectively executing less than an entirety of the script based on the execution instructions.

3. The system of claim 1,
at the firmware:
wherein the one or more control functions of the script comprises a plurality of control functions and wherein the one or more logic functions comprises a plurality of logic functions;
selectively identifying which of the plurality of control functions and/or which of the plurality of the logic functions to execute based on the energy state of the energy source and the energy cost for executing the script;
wherein the execution instructions comprise instructions to execute only a portion and not all of the plurality of control functions and/or a portion and not all of the plurality of logic functions of the script.

4. The system of claim 1, wherein the scripts comprise lambda functions that are dynamically loaded to a dynamic memory of the autonomous device based on an occurrence of a triggering event,
upon occurrence of the triggering event, the lambda function is only loadable to the dynamic memory if one or more control functions and/or one or more logic functions of the lambda function are validated against a digital smart contract, wherein the digital smart contract comprises machine-enforceable contract terms.

5. A method of operating an autonomous device with a computing resource state-aware firmware, the method comprising:
at an autonomous device:
identifying a request to execute a script;
identifying one or more computing resource costs associated with executing the script by one or more computing resources of the autonomous device;
detecting a state of each of the one or more computing resources of the autonomous device;
in response to (i) identifying the one or more computing resource costs and (ii) detecting the state of each of the one or more computing resources of the autonomous device, executing or not executing the scripts.

6. The method of claim 5, wherein the request comprises an indication of one or more control operations and/or one or more logic operations of the script, wherein the wherein identifying the one or more computing resource costs is based on determining a computing cost for each of the one or more control operations and/or the one or more logic operations of the script.

7. The method of claim 5, wherein the script comprises a lambda function, wherein the lambda function comprises a single-purpose script that is dynamically loaded to a dynamic memory of the autonomous device at time of execution.

8. The method of claim 6, wherein identifying the one or more computing resource costs associated with executing the script includes identifying for each of the one or more control operations and/or for each of the one or more logic operations of the script a respective computing cost.

9. The method of claim 5, wherein identifying the one or more computing resource costs associated with executing the script includes:
identifying a memory cost for executing the script, wherein the memory cost comprises an amount of a memory resource of the autonomous device that would be used when executing the script; and
identifying an energy cost for executing the script, wherein the energy cost comprises an amount of an energy resource of the autonomous device that would be used when executing the scripts.

10. The method of claim 5, wherein detecting the state of the one or more computing resources includes one or more of:
(i) identifying an energy level of an energy supply of the autonomous device, wherein the energy level of the energy supply defines an available amount of energy at the energy supply or an amount of energy expended by the energy supply; and
(ii) identifying a memory level of a memory of the autonomous device, wherein the memory level of the memory defines an available amount of memory at the memory or an amount of memory expended by the memory.

11. The method of claim 5, wherein the one or more computing resources comprise an energy supply of the autonomous device, wherein detecting the state of the one or more computing resources includes determining an energy level of the energy supply; and
further comprising:
determining whether or not to execute the script based on the energy level of the energy supply.

12. The method of claim 11, wherein the determining whether or not to execute the script includes:
(i) if the energy level of the energy supply satisfies an execution threshold, then generating instructions to execute the script, or
(ii) if the energy level of the energy supply does not satisfy the execution threshold, then generating instructions not to execute the script.

13. The method of claim 5, further comprising:
executing the script,
wherein executing the script includes selectively executing only a portion of the one or more control operations and/or the one or more logic operations of the script to thereby reduce an amount of the one or more computing resources expended during execution of the script.

14. The method of claim 12, wherein the execution threshold comprises a continuum including a plurality of thresholds, wherein each of the plurality of thresholds, respectively, indicates different execution parameters for different energy levels of the energy supply, the different execution parameters indicating an extent to which a script can be executed;
wherein the determining whether or not to execute the script includes:
comparing the energy level of the energy supply to the plurality of thresholds of the continuum;
identifying one threshold of the plurality of threshold satisfied by the energy level of the energy supply;
identifying execution parameters associated with the one threshold; and
generating instructions to execute a subset of the one or more control operations and/or a subset of the one or more logic operations of the script based on the execution parameters of the one threshold.

15. The method of claim 13, wherein selectively executing only a portion of the one or more control operations and/or the one or more logic operations of the script includes:
identifying a ranking for each of the one or more control operations and/or the one or more logic operations of the script, wherein the ranking includes a high ranking or a low ranking, wherein the high ranking is based on a control operation or a logic operation satisfying or exceeding a critical-to-operation threshold, wherein the low ranking is based on the control operation or the logic operation failing to satisfy the critical-to-operation threshold; and
wherein the portion that is executed includes the one or more control operations and/or the one or more logic operations identified as high in ranking.

16. The method of claim 15, further comprising:
identifying a different portion of the one or more control operations and/or the one or more logic operations of the script as low in ranking; and
redirecting the different portion to a queue based on the low ranking.

17. The method of claim 5, wherein the autonomous devices comprises one or more computer processors that implements firmware and a virtual machine,
wherein the firmware identifies the one or more computing resource costs and detects the state of each of the one or more computing resources; and
wherein the virtual machine executes or does not execute the script based on instructions from the firmware.

18. A method of processing operations of an autonomous device in accordance with a computing resource state, the method comprising:
at an autonomous device:
detecting an occurrence of an event;
determining that the occurrence of the event triggers a potential execution of a script;
validating the event and a functionality of the script against a digital smart contract;
in response to a successful validation of the event and the functionality of the script, dynamically loading the script to a dynamic memory accessible to a virtual machine, wherein the virtual machine is configured to execute the script;
identifying each of the one or more control functions and/or the one or more logic functions of the script by decomposition of the script;
detecting a state of each of the one or more computing resources of the autonomous device;
in response to detecting the state of each of the one or more computing resources of the autonomous device, executing or not executing the scripts.

19. The method of claim 18, wherein a firmware of the autonomous device evaluates the script for execution and previews each of the one or more control operations and/or the one or more logic operations of the script to a firmware,
wherein the firmware decides which of the one or more control operations and/or the one or more logic of the script to execute based on the state of each of the one or more computing resources of the autonomous device.

20. The method of claim 19, wherein the one or more computing resources includes a limited energy source of the autonomous device, wherein the state of the energy source indicates an energy level of the energy source.
